(19) United States
(12) Patent Application Publication
(10) Pub. No.: US 2017/0013334 A1
(43) Pub. Date: Jan. 12, 2017

(54) MOBILE TERMINAL

(71) Applicant: KYOCERA CORPORATION, Kyoto (JP)

(72) Inventors: Mizuho HIDAKA, Kawasaki-shi (JP); Norikazu MORIOKA, Tokyo (JP)

(21) Appl. No.: 15/275,200

(22) Filed: Sep. 23, 2016

Related U.S. Application Data
(63) Continuation of application No. PCT/JP2015/059437, filed on Mar. 26, 2015.

(30) Foreign Application Priority Data
Mar. 26, 2014 (JP) 2014-062930

(51) Int. Cl. H04R 1/02; H04R 7/04; H04R 7/18

(52) U.S. Cl. CPC H04R 1/025; H04R 7/18; H04R 7/04; H04R 2499/11

(57) ABSTRACT

A mobile terminal according to the present disclosure includes a battery, a frame, a film speaker, a speaker holder, and a hold-down. The film speaker is surrounded by the frame and located at the back side of the battery. To the speaker holder, the frame is affixed on the side of a first surface of the film speaker. The hold-down is configured to press at least a part of the frame on the side of a second surface of the film speaker between the film speaker and the battery from the second surface of the film speaker toward the speaker holder.

### CROSS-REFERENCE TO RELATED APPLICATION

The present application is a continuation based on PCT Application No. PCT/JP2015/059437 filed on Mar. 26, 2015, which claims the benefit of Japanese Application No. 2014-062930, filed on Mar. 26, 2014. PCT Application No. PCT/JP2015/059437 is entitled “Mobile Terminal Device”, and Japanese Application No. 2014-062930 is entitled “Mobile Terminal”. The content of which are incorporated by reference herein in their entirety.

### FIELD

Embodiments of the present disclosure relate to mobile terminals, and more particularly relate to a mobile terminal with a speaker built therein.

### BACKGROUND

Conventionally-known mobile terminal devices have been reduced in size and thickness.

### SUMMARY

A mobile terminal according to the present disclosure includes a battery, a frame, a film speaker, a speaker holder, and a hold-down. The film speaker is surrounded by the frame and located at the back side of the battery. To the speaker holder, the frame is affixed on the side of a first surface of the film speaker. The hold-down is configured to press at least a part of the frame on the side of a second surface of the film speaker between the film speaker and the battery from the second surface of the film speaker toward the speaker holder.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an external view of an example showing the appearance of a mobile phone according to an embodiment of the present disclosure, where (A) shows the appearance of the front surface of the mobile phone, and (B) shows the appearance of the back surface of the mobile phone.

FIG. 2A illustrates an example of the structure of a film speaker built in the mobile phone shown in FIG. 1, showing an example of the appearance of the film speaker as seen from the front surface.

FIG. 2B illustrates an example of the structure of the film speaker built in the mobile phone shown in FIG. 1, showing an example of a cross section taken along the line IIB-IIB shown in FIG. 2A.

FIG. 3 is an exploded perspective view showing an example of the overview of the internal structure of the mobile phone shown in FIG. 1.

FIG. 4A is a perspective view showing an example of the outline of the structure of an inner chassis, a secondary battery and a battery holder shown in FIG. 3.

FIG. 4B illustrates an example of the outline of the structure of the inner chassis, the secondary battery and the battery holder shown in FIG. 3, showing an example in which the secondary battery and the battery holder have been attached to the inner chassis.

FIG. 5 illustrates an example of the structure of an attachment frame shown in FIGS. 2A and 2B, where (A) shows the attachment frame as seen from the front side, and (B) shows the attachment frame as seen from the back side.

FIG. 6 illustrates an example in which necessary components are located on the attachment frame shown in FIGS. 2A and 2B, where (A) shows the front side of the attachment frame with a first film speaker and a second film speaker affixed thereto, (B) shows the back side of the attachment frame with the first and second film speakers affixed thereto, (C) shows a state in which a substrate is located, and (D) shows a state in which a first speaker holder and a second speaker holder have been coupled at their inner ends opposed to each other by a coupling member.

FIG. 7 shows an example of a cross section taken along the line VII-VII shown in FIG. 6 at (D).

FIG. 8A shows an example of a state before the inner chassis is fitted within the attachment frame shown in FIG. 6 at (D).

FIG. 8B shows an example of a state in which the inner chassis has been fitted within the attachment frame shown in FIG. 8A.

FIG. 9 shows an example of a cross section taken along the line IX-IX shown in FIG. 8B.

FIG. 10 is a perspective view showing an example of the outline of the structure of an inner chassis, a secondary battery and a battery holder of another embodiment.

FIG. 11 is a perspective view showing an example of the outline of the structure of an inner chassis, a secondary battery and a battery holder of still another embodiment.

### DETAILED DESCRIPTION

Hereinafter, an embodiment of the present disclosure in which film speakers are employed to reduce the entire thickness of a mobile phone will be described.

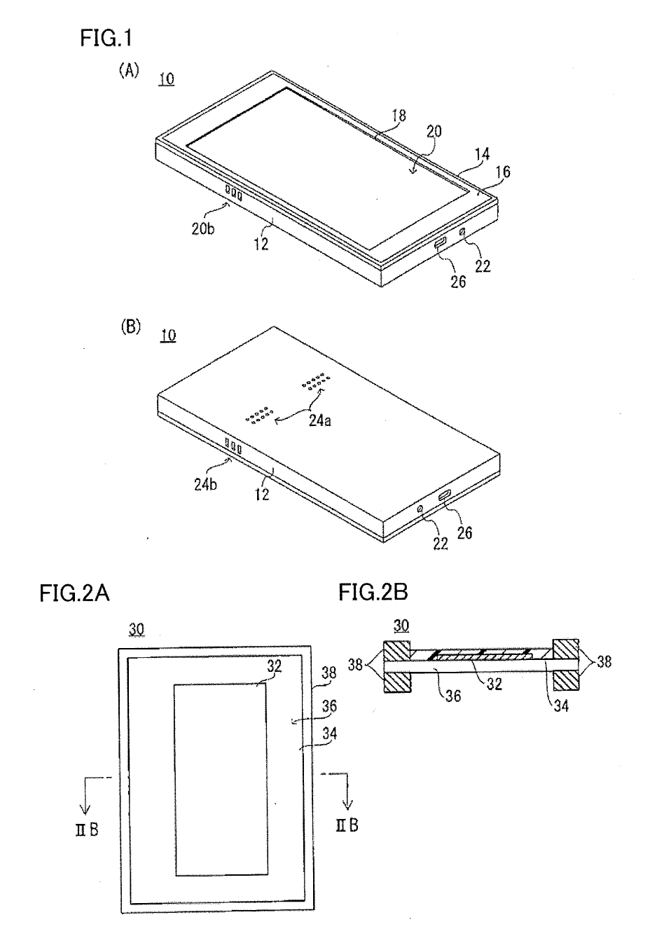

Referring to (A) and (B) in FIG. 1, a mobile phone 10 of an embodiment of the present disclosure is a Smartphone as an example, and the appearance thereof may include a back panel 12, a part of an attachment frame 14 and a front panel 16 so as to present a lengthwise flat rectangle. Back panel 12 includes a main housing member (a member for making up a housing having a principal surface and side surfaces). The part of attachment frame 14 or front panel 16 may serve as the side surfaces of the housing member. The characteristics of the present disclosure are applicable not only to Smartphones but also any mobile terminals, such as a tablet PC (Personal Computer) and a PDA (Personal Digital Assistant).

A touch panel 20 may be integral with front panel 16. A display 18 including, for example, a liquid crystal, organic electroluminescence or the like may have been affixed to the back surface of front panel 16.

A hole 22 through which voice is to be input to a microphone located in the inside may be positioned on a rightward side in a lower surface of mobile phone 10. A piezoelectric element (not shown) which converts sound into vibrations may have been built in the principal surface on the upper side of mobile phone 10. For example, when a sound signal is input to the piezoelectric element, the piezoelectric element can convert the sound signal into vibrations to directly vibrate display 18 (front panel 16). A user can hear sound output from display 18. Since sound is output in this manner, it is not necessary to provide a sound hole through which received voice is to be output, for example.

A first film speaker 30a (described later) and a second film speaker 30b (described later) may have been built into the back surface of mobile phone 10. Sound from first film speaker 30a and second film speaker 30b may be output through first sound holes 24a in the back surface of back panel 12 in an embodiment.

A hole 26 communicating with a charging terminal (not shown) located in the inside may be positioned at the center of the lower surface of mobile phone 10.

For example, when an operation for making a phone call is performed and a voice call is started, received voice may be output from front panel 16 by vibrations of the above-described piezoelectric element. User's uttered voice may be input to the microphone through hole 22, and may be transmitted to a phone device of the other party. When an incoming call from another phone device is notified, a ring tone may be output from a built-in film speaker. Since mobile phone 10 of an embodiment includes built-in first film speaker 30a and second film speaker 30b, it is also possible to play back stereo sound.

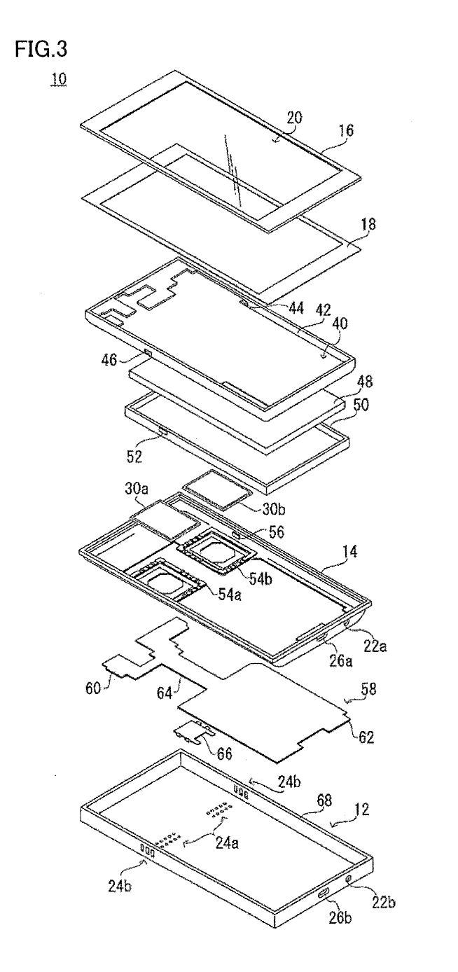

If a charging connector is connected to the charging terminal through hole 26, electric power for charging may be supplied to a secondary battery 48 (see FIG. 3) of mobile phone 10 from an external power source.

FIG. 2A illustrates the appearance of film speaker 30 for use in an embodiment as seen from the front surface. FIG. 2B shows a cross section taken along the line IIB-IIB shown in FIG. 2A. Since film speaker 30 shown in this drawing may be used as first film speaker 30a and second film speaker 30b built in mobile phone 10, description will be made here without distinguishing between the first and second film speakers, and when distinguishing them, reference numbers 30a and 30b will be used.

Film speaker 30 may be a flat rectangle, and may have a thickness of 0.7 mm, for example. Film speaker 30 may include a piezoelectric element 32 which is similarly rectangular. Piezoelectric element 32 may have been coated with resin by a resin coating layer 34 so as to be positioned approximately at the center on the front surface (FIG. 2A) from which sound is output. A resin film 36 may have been affixed to resin coating layer 34. In order to support them, a frame 38 may have been attached to the periphery of film speaker 30. When a sound signal is supplied to piezoelectric element 32 of film speaker 30, piezoelectric element 32 may vibrate. The vibrations may propagate to entire film speaker 30 including resin coating layer 34 and resin film 36, and sound may be output from the front surface of film speaker 30. Frame 38 may be used when fixing film speaker 30 onto a speaker holder 54 (described later).

FIG. 3 is an exploded perspective view showing the overview of the internal structure of mobile phone 10. Referring to FIG. 3, in mobile phone 10, respective parts may be attached in the order of front panel 16, display 18, an inner chassis 42, secondary battery 48, a battery holder 50, first film speaker 30a and second film speaker 30b, attachment frame 14, a substrate 58, a coupling member 66, and back panel 12 from the front surface side (from the upper side in FIG. 3). Attached back panel 12 cooperates with attachment frame 14 to create closed space on the inner side of back panel 12, and sound from first film speaker 30a and second film speaker 30b may be emitted out of the closed space through first sound holes 24a and second sound holes 24b.

Front panel 16 constitutes the principal surface of mobile phone 10, and may be made of glass so as to present a lengthwise flat rectangle, for example. Touch panel 20 may be integral with the back surface of front panel 16. Display 18 may have been bonded to the back surface of front panel 16 with an adhesive or an OCA (Optical Clear Adhesive: transparent adhesive) tape.

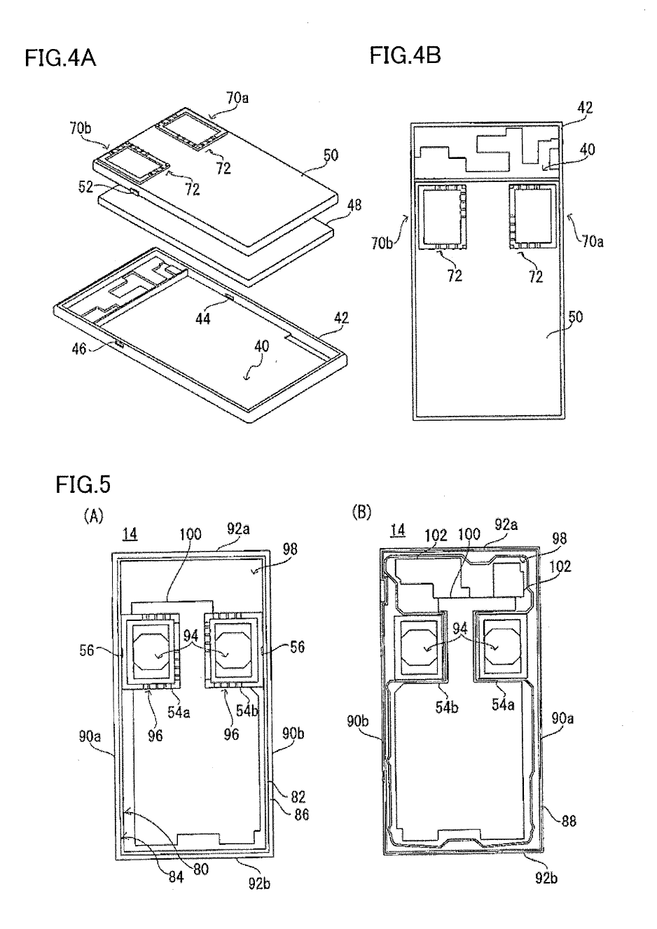

Referring to FIG. 4A together with FIG. 3, inner chassis 42 includes a rectangular resin frame. A shield plate 40 made of metal (a conductive material) may be located within the frame so as to cover almost the entire surface. The frame of inner chassis 42 may have a thickness equal to or slightly thinner than the stacked thickness of shield plate 40, secondary battery 48 and the bottom surface of battery holder 50. Front panel 16 with display 18 affixed thereto as described above may be located on the front side of inner chassis 42 (front side of shield plate 40). A recess in which battery holder 50 holding secondary battery 48 is attached may be located on the back side of inner chassis 42.

Secondary battery 48 has a flat rectangular shape, and may be placed in battery holder 50 made of resin and having a box-like shape as a whole. A first claw 52 is located on the outer side of each of the left and right side surfaces of battery holder 50, and a corresponding first claw receiver (also called an undercut) 44 may be located on the inner side of each of the left and right vertical frames of inner chassis 42. A second claw receiver 46 corresponding to a second claw 56 which will be described later may be located on the outer side of each of the left and right vertical frames of inner chassis 42.

As shown in FIG. 4B, when battery holder 50 holding secondary battery 48 is attached to inner chassis 42, left and right first claws 52 may be engaged with left and right first claw receivers 44, respectively, to cause battery holder 50 to be fixed to inner chassis 42. As a result, secondary battery 48 may be held by battery holder 50.

In this way, secondary battery 48 is held without using any adhesion means, such as a resin tape or an adhesive. Secondary battery 48 may therefore be readily removed and replaced when maintaining mobile phone 10, for example.

A first hold-down 70a and second hold-down 70b pressing first film speaker 30a and second film speaker 30b from the back side, respectively, may be located on the back side of battery holder 50. First hold-down 70a and second hold-down 70b may be rectangular as a whole, and their peripheries may be raised to present a rib shape. The height of first hold-down 70a and second hold-down 70b may be set such that first hold-down 70a and second hold-down 70b come into contact with first film speaker 30a and second film speaker 30b, respectively, when inner chassis 42 with battery holder 50 attached thereto is fitted within attachment frame 14. The positions at which first hold-down 70a and second hold-down 70b are located may correspond to the positions of first speaker holder 54a and second speaker holder 54b at which first film speaker 30a and second film speaker 30b are located, respectively.

A plurality of notches 72 and a wiring recess for letting wires pass to film speaker 30 may be located in first hold-down 70a and second hold-down 70b. Plurality of notches 72 may be located at positions corresponding to a plurality of notches 96 located in the ribs of first speaker holder 54a and second speaker holder 54b.

When it is not necessary to distinguish between first hold-down 70a and second hold-down 70b in the following description, they will be called “hold-down 70” collectively.

Referring to (A) and (B) in FIG. 5 together with FIG. 3, attachment frame 14 may be rectangular similarly to front panel 16 and inner chassis 42, and the frame including a pair of vertical frames 90 (a first pair of frame members) and a pair of horizontal frames 92 (a second pair of frame members) may have been formed by resin molding together with respective parts which will be described below. A first vertical frame 90a and a second vertical frame 90b may be located at a predetermined spacing. A first horizontal frame 92a may couple the pair of vertical frames 90 at the upper side, and a second horizontal frame 92b may couple the pair of vertical frames 90 at the lower side.

A first speaker holder 54a and a second speaker holder 54b, both having a plate-like shape, may extend inwardly from the inner sides of first vertical frame 90a and second vertical frame 90b, respectively, to be opposed to each other. An octagonal second sound hole 94, for example, may be located at the center of each of first speaker holder 54a and second speaker holder 54b in order to emit sound of first film speaker 30a and second film speaker 30b held therein. When it is not necessary to distinguish between first speaker holder 54a and second speaker holder 54b in the following description, they will be called “speaker holder 54” collectively.

A rib with notches 96 may be located on the periphery of the front surface of each of first speaker holder 46a and second speaker holder 46b. First speaker holder 54a and second speaker holder 54b have a flat rectangular plate-like shape in an embodiment, but are not limited to this shape. Each of first speaker holder 54a and second speaker holder 54b should just include an area to which frame 38 of film speaker 30 on the front side can be affixed with a resin tape or the like. Second sound hole 94 may be larger or smaller than that shown in FIG. 5.

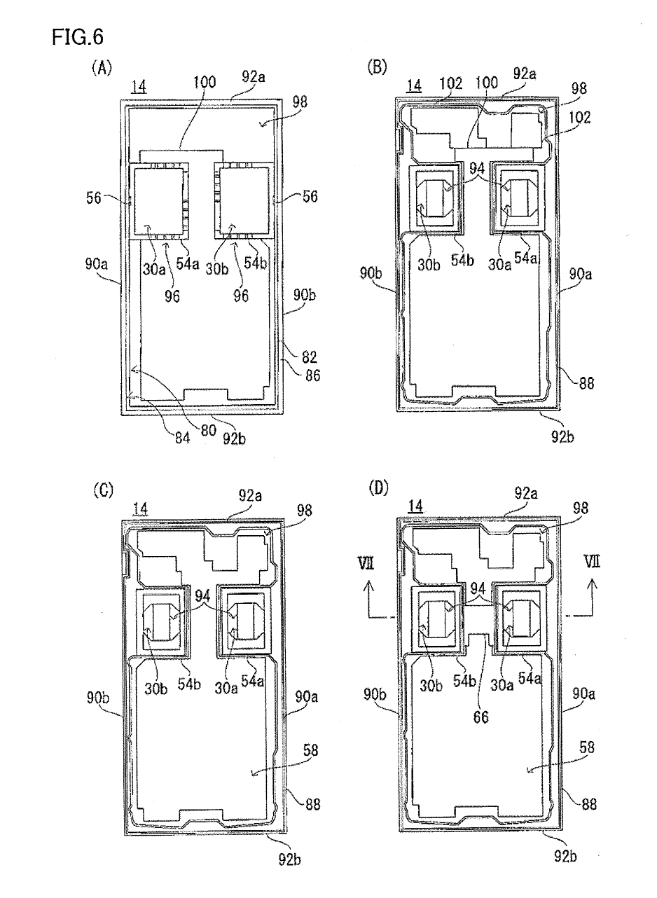

Inner chassis 42 is fitted within attachment frame 14. The inner side of the pair of vertical frames 90 and the pair of horizontal frames 92 includes an inner wall 80 (also see FIGS. 6 to 9, etc.) where inner chassis 42 can be fitted. Inner wall 80 may come into contact with the outer surface of the resin frame of inner chassis 42 so that inner chassis 42 is fitted into attachment frame 14. Left and right second claws 56 located at attachment frame 14 may be engaged with left and right second claw receivers 46 located in inner chassis 42, respectively, so that inner chassis 42 may be fixed at attachment frame 14.

A recess 82 and an inner wall 84 (for both, also see FIGS. 6 to 9, etc.) where front panel 16 is to be attached may be located on the upper side of attachment frame 14. A portion 86 (also see FIGS. 6 to 9, etc.) on the outer side with respect to recess 82 includes an exposed portion exposed as a part of the appearance (FIG. 1) of mobile phone 10. When front panel 16 is attached to the inner side of inner wall 84 and into recess 82, front panel 16 and outer portion 86 may be in an identical or generally identical plane (flush with each other).

A recessed second fitting portion 88 (also see FIGS. 6, 7, 9, etc.) may be located on the back side of attachment frame 14. A projecting first fitting portion 68 (also see FIG. 3 etc.) is located on a side surface of back panel 12. When first fitting portion 68 is fitted into second fitting portion 88, back panel 12 may be attached to attachment frame 14.

An assembling portion 98 for assembling components, such as a camera unit, for example, may be located in an area ranging from the inner side of first horizontal frame 92a to the upper edges of first speaker holder 54a and second speaker holder 54b. A rectangular hole 100 through which wires and the like pass may be located in assembling portion 98. On the back side of attachment frame 14 ((B) in FIG. 5), two substrate recesses 102 ((B) in FIG. 5) in which substrate 58 having a shape as shown in FIG. 3 is to be placed may be located in assembling portion 98. As understood from FIG. 3, a hole 22a communicating with the microphone and a hole 26a communicating with the charging terminal may be located in the side surface of second horizontal frame 92b.

Returning to FIG. 3, substrate 58 is made of resin, glass fibers or the like, and includes an irregular-shape first portion 60, a generally rectangular second portion 62 and a narrow third portion 64 connecting first portion 60 and second portion 62. On substrate 58, predetermined wires may be placed, and necessary components, such as a microphone, may be mounted.

The shape and size of first portion 60, second portion 62 and third portion 64 of substrate 58 are not limited to those of an embodiment.

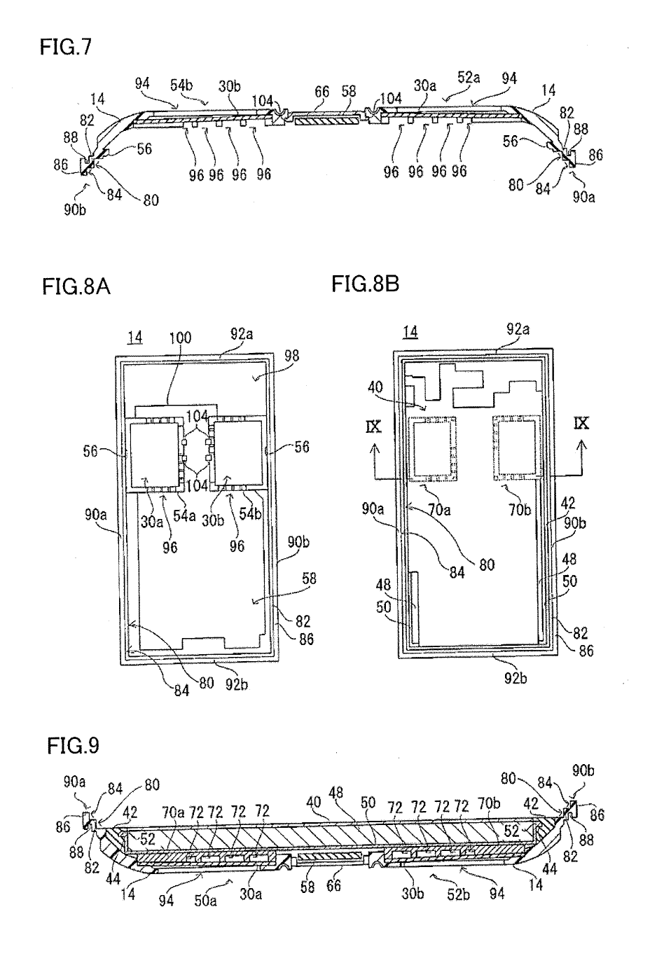

Coupling member 66 is made of resin or the like, and includes two engaging portions 104 (see FIG. 7) on each of the left and right sides. The inner ends of first speaker holder 54a and second speaker holder 54b opposed to each other may be coupled to each other by coupling member 66. How to attach them will be described later in detail.

As shown in FIG. 1, back panel 12 serving as the main housing member as described above may be made of resin so as to present a shape such as a rectangular box which constitutes the side surfaces and the bottom surface (back surface) of mobile phone 10. First sound holes 24a may be located in the principal surface (bottom surface) of back panel 12, and second sound holes 24b may be located in the left and right side surfaces of back panel 12. A hole 22b communicating with the microphone and a hole 26b communicating with the charging terminal may be located in the lower surface of back panel 12.

Inner chassis 42, secondary battery 48, first film speaker 30a, second film speaker 30b, substrate 58, and coupling member 66 as described above may be located on attachment frame 14. Front panel 16 may be located on the front side of attachment frame 14, and back panel 12 may be located on the back side.

The procedure of attaching components to attachment frame 14 will be described. First, referring to (A) and (B) in FIG. 6, first film speaker 30a and second film speaker 30b may be arranged such that their front surfaces face first sound holes 24a by means of first speaker holder 54a and second speaker holder 54b, respectively. Specifically, on the front side of attachment frame 14, first film speaker 30a and second film speaker 30b may be affixed to first speaker holder 54a and second speaker holder 54b, respectively, with a resin tape, also called a double-faced tape, adhered to frame 38. First film speaker 30a and second film speaker 30b may be located such that their surfaces (front surfaces) from which sound is to be output face corresponding second sound holes 94. In this state, first film speaker 30a and second film speaker 30b are visible through each of second sound holes 94 from the back side of attachment frame 14.

Referring to (C) and (D) in FIG. 6, substrate 58 may be located on the back side of attachment frame 14. First portion 60 may be located above first speaker holder 54a and second speaker holder 54b so as to overlap a part of attachment portion 98. Second portion 62 may be located below first speaker holder 54a and second speaker holder 54b. Third portion 64 may be located so as to extend between first speaker holder 54a and second speaker holder 54b and so as to be generally flush with first film speaker 30a and second film speaker 30b. Hole 100 and substrate recess 102 located in assembling portion 98 may be hidden by substrate 58. Since substrate 58 is located on the back side of attachment frame 14 so as to avoid first film speaker 30a and second film speaker 30b, the thicknesses of first film speaker 30a and second film speaker 30b may be included in the thickness of substrate 58. Since first film speaker 30a and second film speaker 30b can be located in a plane identical to or generally identical to substrate 58, the thickness can be reduced further. Since third portion 64 connects first portion 60 and second portion 62, and coupling member 66 couples first speaker holder 54a and second speaker holder 54b straddling third portion 64, first speaker holder 54a and second speaker holder 54b having high rigidity can be obtained without reducing the available area of substrate 58.

Next, as shown in FIG. 6 at (D), coupling member 66 may be engaged with first speaker holder 54a and second speaker holder 54b from above third portion 64 of substrate 58 so as to couple the inner ends of first speaker holder 54a and second speaker holder 54b opposed to each other.

In more detail, referring to FIG. 7 showing a cross section taken along the line VII-VII in FIG. 6 at (D), a claw may be located at the leading end of each engaging portion 104. When coupling member 66 is pressed from above on the back side of attachment frame 14, engaging portion 104 can be temporarily bent inwardly. When coupling member 66 is pressed further so that the leading end of engaging portion 104 reaches the front side of attachment frame 14, engaging portion 104 can be returned to its original shape. The claws at the leading ends of engaging portions 104 may be caught at the peripheries of first speaker holder 54a and second speaker holder 54b, and coupling member 66 may be fixed between first speaker holder 54a and second speaker holder 54b.

As a result, first speaker holder 54a and second speaker holder 54b may be firmly coupled by coupling member 66 to be changed from a cantilever beam structure (the state shown in FIG. 5, etc.) to a both-ends-supported beam structure. Since first speaker holder 54a and second speaker holder 54b are integral with each other, each of them increases in rigidity. Since vibrations of first speaker holder 54a and second speaker holder 54b themselves are suppressed, first film speaker 30a and second film speaker 30b can be increased in sound pressure level.

For example, if first speaker holder 54a and second speaker holder 54b are not coupled together by this connecting member 66, first speaker holder 54a and second speaker holder 54b remain in the cantilever beam structure, and the rigidity of the structure supporting first film speaker 30a and second film speaker 30b does not need to be large. When voice is output from first film speaker 30a and second film speaker 30b in this state, first film speaker 30a and second film speaker 30b vibrate. First speaker holder 54a and second speaker holder 54b also vibrate accordingly, and the vibrations can reduce the vibrations of first film speaker 30a and second film speaker 30b. If first speaker holder 54a and second speaker holder 54b are coupled together by coupling member 66 into the both-ends-supported beam structure as in an embodiment, the sound pressure is improved by about 3 dB.

When attaching back panel 12 to attachment frame 14, an adhesive may be applied to coupling member 66, and coupling member 66 may be bonded and fixed to back panel 12. First speaker holder 54a and second speaker holder 54b will be reinforced also by back panel 12, so that a further improvement in sound pressure can be expected.

In another embodiment, a recess may be located in coupling member 66 in order to prevent the adhesive applied to coupling member 66 from flowing out.

FIG. 8A illustrates a state before inner chassis 42 is fitted within the attachment frame shown in FIG. 6 at (D). Substrate 58 may be partly visible below hole 100, first speaker holder 54a and second speaker holder 54b. The claws at the leading ends of engaging portions 104 of coupling member 66 may be caught on the right side of first speaker holder 54a and the left side of second speaker holder 54b. As shown in FIG. 8A, coupling member 66 may couple first speaker holder 54a and second speaker holder 54b such that engaging portions 104 are fitted within some of notches 96 of first speaker holder 54a and second speaker holder 54b.

Referring to FIG. 8B, when inner chassis 42 holding secondary battery 48 is fitted within attachment frame 14, then, substrate 58, first film speaker 30a, second film speaker 30b, first speaker holder 54a, second speaker holder 54b, and the like are hidden by inner chassis 42. The positions of first hold-down 70a and second hold-down 70b in FIG. 8B are indicated by the dotted line.

Referring to FIG. 9 showing a cross section taken along the line IX-IX of FIG. 8B, the state in which battery holder 50 holds secondary battery 48 is clearly seen. Secondary battery 48 is located on shield plate 40, and is therefore unlikely to fall out from battery holder 50.

First film speaker 30a and second film speaker 30b are held by first speaker holder 54a and second speaker holder 54b, respectively, on the back side of secondary battery 48. By employing and placing film speaker 30 on the back side of secondary battery 48, mobile phone 10 can be reduced in thickness as a whole.

As shown in FIG. 9, inner chassis 42 holding secondary battery 48 may be fitted within inner wall 80 of attachment frame 14. The thickness of attachment frame 14 may include the thicknesses of shield plate 40, inner chassis 42, secondary battery 48, and the bottom surface of battery holder 50. Even if inner chassis 42 with battery holder 50 holding secondary battery 48 fitted therein is fitted into attachment frame 14, the thickness of attachment frame 14 is unlikely to be changed. Even if inner chassis 42 with battery holder 50 holding secondary battery 48 fitted therein is fitted into attachment frame 14, secondary battery 48, battery holder 50 and inner chassis 42 are unlikely to protrude from attachment frame 14 in the thickness direction of attachment frame 14. With such a configuration, mobile phone 10 can also be reduced in thickness as a whole.

First hold-down 70a and second hold-down 70b may be in contact with portions of frame 38 of first film speaker 30a and second film speaker 30b because of the presence of notches 72 and wiring recesses. Battery holder 50 in which first hold-down 70a and second hold-down 70b are located may have been fixed to inner chassis 42, and this inner chassis 42 may have been fixed to attachment frame 14. Battery holder 50 may have been fixed to attachment frame 14 with inner chassis 42 interposed therebetween. First hold-down 70a and second hold-down 70b may be pressing first film speaker 30a and second film speaker 30b (frame 38) from the back side of first film speaker 30a and second film speaker 30b toward first speaker holder 54a and second speaker holder 54b, respectively. By being interposed between speaker holder 54 and hold-down 70 from both of the front and back surfaces, film speaker 30 may be fixed firmly. As a result, unnecessary vibrations of film speaker 30 are suppressed, which can further improve the sound pressure of film speaker 30.

Notches 72 in hold-down 70 may correspond to notches 96 in the rib of speaker holder 54. Even if film speaker 30 is surrounded by speaker holder 54, the inner side and the outer side of speaker holder 54 and hold-down 70 may communicate with each other through notches 72 of hold-down 70 pressing film speaker 30 and notches 96 in speaker holder 54. The back side capacity of first film speaker 30 can thus be ensured sufficiently, and first film speaker 30 can be improved in acoustic performance.

Even if secondary battery 48 is expanded with time by repeated charging and discharging, secondary battery 48 cannot be displaced further toward first film speaker 30a because secondary battery 48 contacts the bottom surface of battery holder 50. The gap between film speaker 30 and secondary battery 48 may be stably ensured.

Since the upper and right sides of first hold-down 70a as well as the upper and left sides of second hold-down 70b are substantially the same as those in the state of FIG. 9, an illustration will not be given.

In another embodiment, in order to further improve the sound pressure level of film speaker 30, a rib of speaker holder 54 may be fixed (bonded) to battery holder 50 by a fixing member or fixing means, such as an adhesive. Specifically, battery holder 50 holding secondary battery 48 having the maximum weight and the highest rigidity in mobile phone 10 of an embodiment may be used to fix speaker holder 54 onto battery holder 50. In another embodiment, a double-faced tape, a fitting (engagement) mechanism or the like may be used to fix the rib of speaker holder 54 to battery holder 50.

Although not shown, after back panel 12 is attached to attachment frame 14, first film speaker 30a, second film speaker 30b, first speaker holder 54a, second speaker holder 54b, substrate 58, coupling member 66, second fitting portion 88, the pair of vertical frames 90, the pair of horizontal frames 92, sound holes 94, and assembling portion 98 may be hidden by back panel 12. At this time, the front surfaces of first film speaker 30a and second film speaker 30b may face first sound holes 24a located in the bottom surface of back panel 12.

The closed space created by the cooperation of back panel 12 and attachment frame 14 may function as a duct through which sound comes out from the bottom surface of back panel 12 and a duct through which sound comes out from the side surface. The sound output from first film speaker 30a may be output through first sound holes 24a located in the front surface of first film speaker 30a and second sound holes 24b located in the side surface of back panel 12 corresponding to first sound holes 24a, so that the flow of the sound output from first film speaker 30a may be in two directions. When monaural sound is output from first film speaker 30a and second film speaker 30b, the sound is emitted from two locations at the back surface and two locations at the side surface of the housing member. The output sound can spread around and can give the surround effect to sound output from first film speaker 30a and second film speaker 30b. When stereo sound is output from first film speaker 30a and second film speaker 30b, the sound on the left and right sides output from the two places at the side surfaces, respectively, may reach the user's ears in a substantially independent manner. Since the independence of sound on the left and sound on the right output from first film speaker 30a and second film speaker 30b increases, sound having a sufficient degree of separation between the left and right sides and a higher stereo effect can be output. In this way, realistic sound can be output in an embodiment.

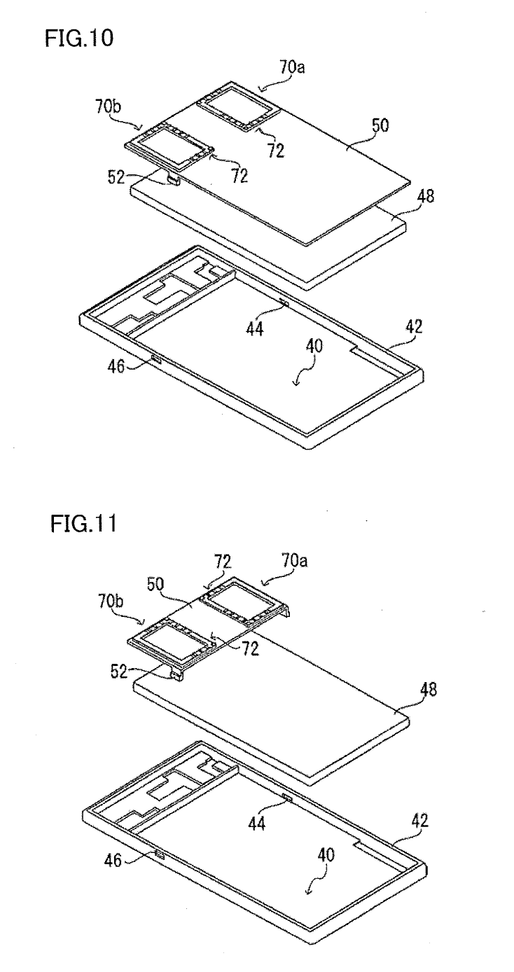

Battery holder 50 of the above-described embodiment has a box-like shape, but may have another shape in another embodiment. Referring to FIG. 10, battery holder 50 of another embodiment may have a plate-like shape. Plate-like battery holder 50 may have no side surfaces except the portions corresponding to the bottom surface of battery holder 50 and first claws 52 of an embodiment. Referring to FIG. 11, battery holder 50 of another embodiment has a shape only including the neighborhood of first hold-down 70a and second hold-down 70b as well as first claws 52. A large part of the side surfaces and more than half of the bottom surface of battery holder 50 of the above-described embodiment may be absent. Even with these shapes, battery holder 50 can hold secondary battery 48, and first hold-down 70a and second hold-down 70b located on the bottom surface of battery holder 50 can press first film speaker 30a and second film speaker 30b, respectively.

Battery holder 50 is fixed to attachment frame 14 with inner chassis 42 interposed therebetween. In another embodiment, there may be a claw and a claw receiver such that battery holder 50 is directly fixed to attachment frame 14.

In another embodiment, the number and position of first claw receiver 44 and second claw receiver 46 located on inner chassis 42, first claw 52 located on battery holder 50, and second claw 56 located on attachment frame 14 may differ from those of the above-described embodiment. In another embodiment, the positions of first claw 52 and first claw receiver 44 and the positions of second claw 56 and second claw receiver 46 may be reversed entirely or partly. For example, in another embodiment, first claw 52 and second claw 56 may be located on inner chassis 42, and first claw receiver 44 and second claw receiver 46 may be located on battery holder 50 and attachment frame 14.

The shape of first sound holes 24a and second sound holes 24b is not limited to circle or rectangle, but may have various shapes in another embodiment. In the above-described embodiment, back panel 12 has an angled box-like shape (a shape having side surfaces orthogonal to a principal surface), and first sound holes 24a and second sound holes 24b are located in the vertical side surfaces. The side surfaces may be inclined or curved with respect to a principal surface such that the corners are roundish. Even in this case, first sound holes 24a and second sound holes 24b may be located in the inclined or curved side surfaces at the position corresponding to the side surfaces of the above-described embodiment.

In the above-described embodiment, back panel 12 serves as the principal surface and side surfaces of the housing member. When back panel 12 only serves as the principal surface, and attachment frame 14, for example, rather than back panel 12, serves as the side surfaces, first sound holes 24a and second sound holes 24b may be located in attachment frame 14. When front panel 16 serves as the side surfaces of the housing member, for example, first sound holes 24a and second sound holes 24b may be located in front panel 16.

In the above-described embodiment, substrate 58 includes first portion 60, second portion 62 and third portion 64, but can be variously modified in shape.

For example, substrate 58 may be a single large rectangular substrate, and may be located under attachment frame 14 so as to overlap attachment frame 14. In this case, reduction in thickness by the thickness of substrate 58 being included in the thicknesses of first film speaker 30a and second film speaker 30b cannot be expected. It is not necessary to locate first speaker holder 54a and second speaker holder 54b separately. Even without using coupling member 66, first speaker holder 54a and second speaker holder 54b can be brought into a both-ends-supported structure to increase rigidity.

Alternatively, the substrate may only correspond to second portion 62. Also in this case, first speaker holder 54a and second speaker holder 54b can be originally integral with each other without using coupling member 66.

In the above-described embodiment, first film speaker 30a, second film speaker 30b, the rib of speaker holder 54, and hold-down 70 each have a rectangular shape. In another embodiment, the shape of at least one or all of them is not limited to rectangle, but may have a roundish or another shape.

In the above-described embodiment, the rib surrounds first film speaker 30a and second film speaker 30b along the entire circumference. In another embodiment, there may be a rib corresponding to at least one side of each of first film speaker 30a and second film speaker 30b. The rib does not need to surround first film speaker 30a and second film speaker 30b.

In the above-described embodiment, two film speakers 30a and 30b are used. For further size reduction of the mobile terminal or further increase of the internal space, only a single film speaker 30 may be adopted. In this case, only a single first sound hole 24a is located in the principal surface of the housing member, and only a single second sound hole 24b is located in a side surface of the housing member at the position corresponding to that first sound hole 24a. Even when only a single film speaker 30 is used, sound is output through both of first sound hole 24a and second sound hole 24b spaced at a certain distance from first sound hole 24a. Compared with the case of using first sound hole 24a alone, a realistic feeling may be improved.

All the specific numerical values mentioned in the present specification are mere examples, and can be varied as appropriate depending on changes to product specifications or the like.

Although the present disclosure has been described and illustrated in detail, it is clearly understood that the same is by way of illustration and example only and is not to be taken by way of limitation, the scope of the present disclosure being interpreted by the terms of the appended claims.

1. A mobile terminal comprising:
a battery;
a frame;
a film speaker surrounded by the frame and located at the back side of the battery;
a speaker holder to which the frame is affixed on the side of a first surface of the film speaker; and
a hold-down configured to press at least a part of the frame on the side of a second surface of the film speaker between the film speaker and the battery from the second surface of the film speaker toward the speaker holder.

2. The mobile terminal according to claim 1, wherein a notch is formed on the hold-down.

3. The mobile terminal according to claim 1, further comprising a battery holder configured to hold the battery, wherein
the hold-down is located on the battery holder so as to face the film speaker.
